(19) United States
(12) Patent Application Publication
(10) Pub. No.: US 2006/0187582 A1
(43) Pub. Date: Aug. 24, 2006

(54) Electrical read head having high sensitivity and resolution power and method of operating the same

(75) Inventors: Yong-su Kim, Seoul (KR); Jae-hak Choi, Seoul (KR); Ju Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/345,366

(22) Filed: Feb. 2, 2006

(30) Foreign Application Priority Data
Feb. 2, 2005 (KR) 10-2005-0009740

(51) Int. Cl. G11B 5/147

(52) U.S. Cl. 360/126

(57) ABSTRACT

An electrical read head having high sensitivity and resolution power and a method of operating the same are provided. The electrical read head includes a core portion for recording/reading data on/from a recording medium and an electrode pad connecting the core portion to a power supply. A surface of the core portion facing the recording medium is a plane surface and side surfaces of the core portion are perpendicular to the plane surface.

### CROSS-REFERENCE TO RELATED PATENT APPLICATION

This application claims the benefit of Korean Patent Application No. 10-2005-0009740 filed on Feb. 2, 2005, in the Korean Intellectual Property Office, the disclosure of which is incorporated herein in its entirety by reference.

### BACKGROUND OF THE INVENTION

1. Field of the Invention

The present invention relates to a measuring apparatus and a method of operating the same, and more particularly, to an electrical read head having high sensitivity and resolution power and a method of operating the same.

2. Description of the Related Art

A key point in recording and reading data by a read head (probe) method is to increase the sensitivity and resolution power of the read head. The read head must have high resolution power to sense the polarization of a small area in a recording medium in order to record data at high density. Moreover, since a small polarization variation occurs, the read head must have a great resistance variation and a voltage variation, i.e., high sensitivity.

Various types of read heads such as a field effect transistor (FET) probe type read head, a resistive probe type read head, and an EFM probe type read head are widely used.

These read heads are appropriate for measuring physical quantities, such as a concentration of impurities doped in a predetermined region of a wafer. However, these read heads do not have a sensitivity and resolution power high enough to record data at high density and read high-density data.

### SUMMARY OF THE INVENTION

The present invention provides an electrical read head having an increased sensitivity that can increase a signal-to-noise ratio and resolution power.

The present invention also provides a method of operating an electrical read head to record and read data.

According to an aspect of the present invention, there is provided an electrical read head including a core portion for recording/reading data on/from a recording medium and an electrode pad connecting the core portion to a power supply, wherein a surface of a core portion facing the recording medium is a plane surface and side surfaces of the core portion are perpendicular to the plane surface.

The electrical read head may further include an insulating layer covering both side surfaces of the core portion and the electrode pad; and a shield layer covering a side surface of the insulating layer.

The core portion may include a nonconductive region and a conductive region.

The core portion may be a pure semiconductor layer. The conductive region may be a region doped with conductive impurities.

According to another aspect of the present invention, there is provided a method of operating a read head including a core portion, an electrode pad connecting the core portion to a power supply, an insulating layer covering both side surfaces of the core portion and the electrode pad, and a shield layer covering a side surface of the insulating layer, the method including: grounding the shield layer when reading data from a recording medium having a conductive layer attached to a bottom thereof using the read head.

The conductive layer may also be grounded.

A surface of the core portion facing the recording medium may be a plane surface and side surfaces of the core portion may be perpendicular to the plane surface. The core portion may include a nonconductive region and a conductive region.

Accordingly, the present invention can increase the track density of the recording medium, that is, Track-Per-Inch (TPI), and signal-to-noise ratio.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view illustrating a read head and a recording medium used for implementing an electrical read head according to the present invention;

FIG. 2 is a three-dimensional graph illustrating a variation of a read voltage according to a polarization angle ⊖p and a probe angle ⊖r of the read head in FIG. 1;

FIG. 3 is a graph illustrating a variation of an equipotential line for a read voltage according to a polarization angle ⊖p and a read head angle Or of a read head in FIG. 1;

FIG. 4 is a plane view of the electrical read head to which a result of measurement for the read head in FIG. 1 is applied according to the present invention;

FIG. 5 is a sectional view illustrating an electrical read head and a recording medium to which a result of measurement for the read head shown in FIG. 1 is applied according to an embodiment of the present invention;

FIG. 6 is a plane view of the electrical read head to which a result of measurement for the read head in FIG. 1 is applied according to another embodiment of the present invention;

FIG. 7 is a front view illustrating a core portion separated from the electrical read head shown in FIG. 6 and a position of an electrode pad in the core portion;

FIG. 8 is a sectional view for explaining a method of operating an electrical read head in a data read operation according to a first embodiment of the present invention;

FIG. 9 is a three-dimensional graph illustrating a variation of a read voltage according to a shield width Xs and a distance Xd between a shield layer and a core portion when the shield layer is grounded in a data read operation;

FIG. 10 is a three-dimensional graph illustrating a variation of a read voltage according to a shield width Xs and a core width Xp when the shield layer is grounded in a data read operation;

FIG. 11 is a graph illustrating a variation of an equipotential line for a read voltage according to a shield width Xs and a distance Xd between a shield layer and a core portion;

FIG. 12 is a graph illustrating a variation of an equipotential line for a read voltage according to a shield width Xs and a core width Xp;

FIG. 13 is a three-dimensional graph illustrating a contour read voltage variation according to a core width Xp and a distance Xd between a shield layer and a core portion when the electrical read head is used as shown in FIG. 8;

FIG. 14 is a graph illustrating a variation of an equipotential line for a read voltage according to a result in FIG. 13;

FIG. 15 is a sectional view illustrating a method of operating an electrical read head in a data read operation according to a second embodiment of the present invention;

FIGS. 16 through 21 are graphs illustrating a read voltage variation and a variation of an equipotential line for a read voltage according to a shield width Xs and at least one of a distance Xd between a shield layer and a core portion and a core width Xp when the electrical read head is used as shown in FIG. 15; and

FIGS. 22 through 24 are graphs illustrating an output of a read voltage when a recording medium moves about 100 nm under conditions that a shield width Xs is 50 nm, a distance Xd between a shield layer and a core portion is 10 nm, and a core width Xp is 50 nm.

### DETAILED DESCRIPTION OF THE INVENTION

Hereinafter, exemplary embodiments of the present invention will be described in detail with reference to the attached drawings. In the drawings, the thicknesses of layers and regions are exaggerated for clarity.

FIG. 1 is a sectional view of a resistive probe type read head. Reference numerals 10, 12, and 14 represent a recording medium, a conductive layer disposed under the recording medium, and a read head, respectively. The read head 14 shown has the same shape as a conventional resistive read head. The read head 14 has a tip having a surface S that faces the recording medium 10. A distance between the recording medium 10 and the read head 14 is a distance between the recording medium 10 and the surface S. A vertical arrow in the recording medium 10 represents a direction of a residual polarization in a corresponding domain. A reference symbol ⊖p represents a polarization angle between a slant surface 14s of the read head 14 and a polarization direction of the read head 14. Also, a reference symbol ⊖r represents a read head angle between the surface S of the read head 14 and the slant side 14s. The polarization angle ⊖p and the read head angle ⊖r are very important variables in designing the read head of the present invention.

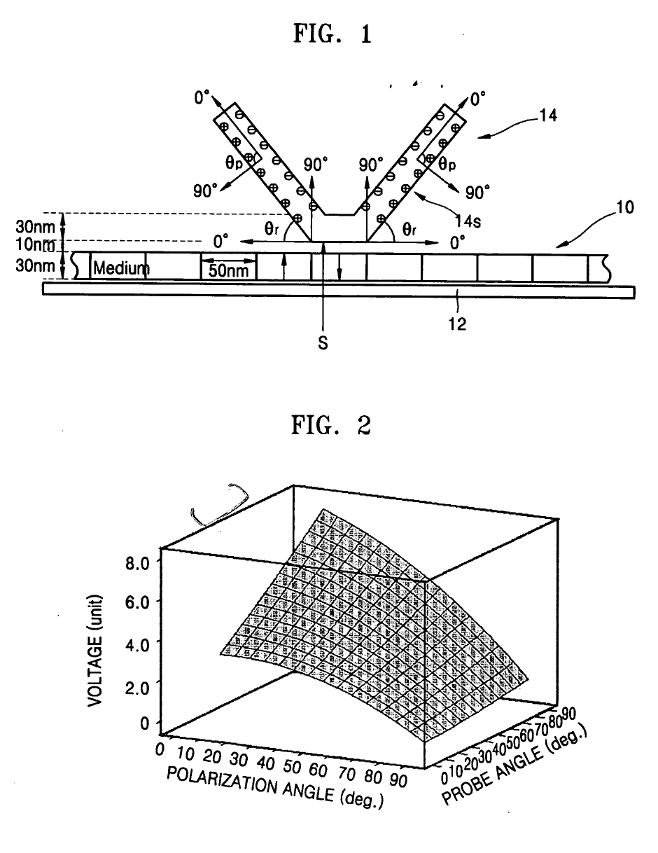

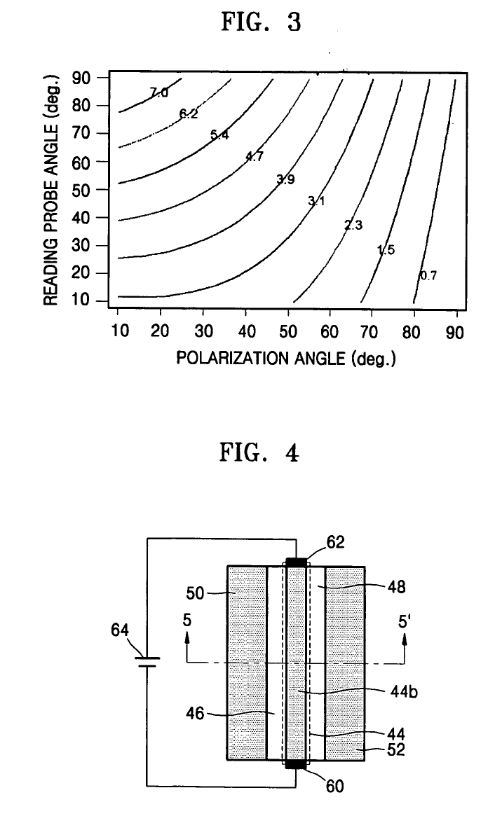

FIGS. 2 and 3 illustrate a variation of a read voltage in the read head 14 according to the polarization angle ⊖p and the read head angle ⊖r. The read voltage is an electric potential difference generated in the read head 14 according to polarization states of the recording medium 10.

FIG. 2 is a three-dimensional graph illustrating a variation of a read voltage in the read head 14 shown in FIG. 1, and FIG. 3 is a graph of an isoelectic line for a read voltage illustrating a variation of a read voltage in the read head 14 shown in FIG. 1.

Referring to FIGS. 2 and 3, the read voltage is larger, when the polarization angle ⊖p is smaller and the read head angle ⊖r is larger. This means that the electrical read head having the smallest polarization angle ⊖p and the largest read head angle ⊖r produces the highest read voltage.

FIG. 4 is a plane view of the electrical read head 40 according to the present invention. Referring to FIG. 4, first and second electrode pads 60 and 62 are disposed at both ends of a core portion 44, respectively. The first and second electrode pads 60 and 62 are connected to a power supply 64. Referring to FIG. 6, the first and second electrode pads 60 and 62 may be disposed between the core portion 44 and the second insulating layer 48. In addition, positions of the first and second electrode pads 60 and 62 may have other positions.

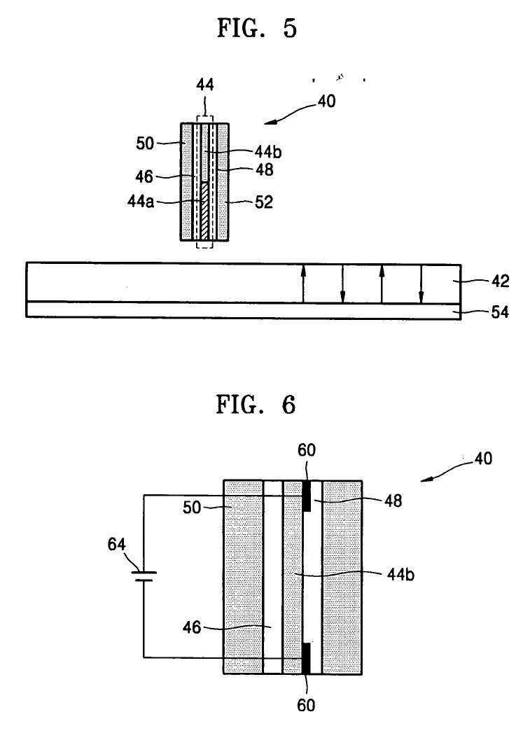

FIG. 5 is a sectional view taken along line 5-5′ of FIG. 4. In FIG. 5, the size of the electrical read head 40 is exaggerated for clarity.

Referring to FIG. 5, the electrical read head 40 includes a core portion 44 for recording/reading data on/from a recording medium 42, first and second insulating layers 46 and 48 covering both sides of the core portion 44, a first shield layer 50 covering side surfaces of the first insulating layer 46, and a second shield layer 52 covering side surfaces of the second insulating layer 48. A reference numeral 54 represents a conductive layer attached to a bottom of the recording medium 42. The first and second insulating layers 46 and 48 may be formed with a silicon oxide layer, and the first and second shield layers 50 and 52 may be formed with a conductive layer. The core portion 44 is formed with a semiconductor layer and includes an electrically nonconductive region 44b and an electrically conductive region 44a. The conductive region 44a is a region doped with conductive impurities in a pure semiconductor layer. Also, the conductive region 44a faces the recording medium 42 and its resistance changes according to the polarization states of the recording medium 42. The nonconductive region 44b is a region of the pure semiconductor layer in which the conductive impurities are not doped.

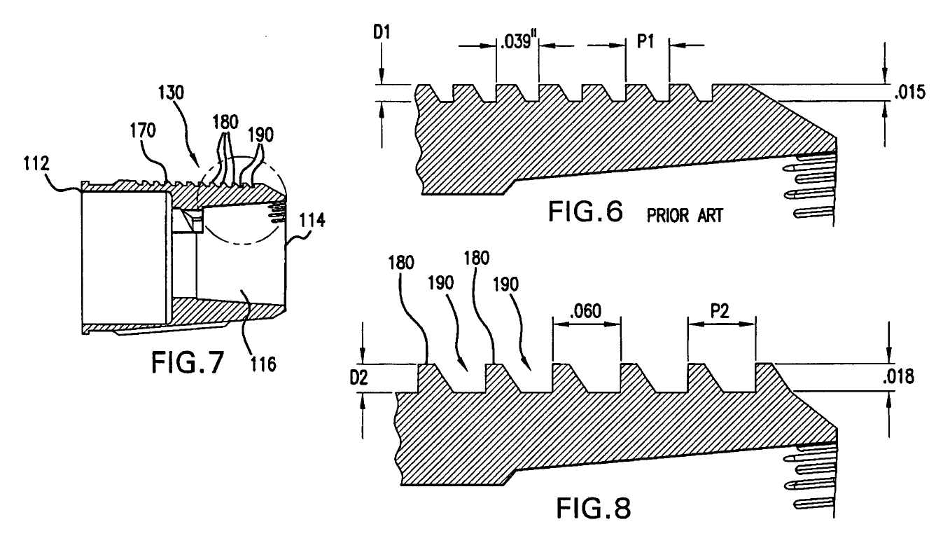

FIG. 7 illustrates the core portion 44 separated from the electrical read head 40 shown in FIG. 6. Referring to FIGS. 6 and 7, the first and second electrode pads 60 and 62 are disposed along the conductive region 44a and the nonconductive region 44b. The power supply 64 is applied to both ends of the conductive region 44a through the first and second electrode pads 60 and 62.

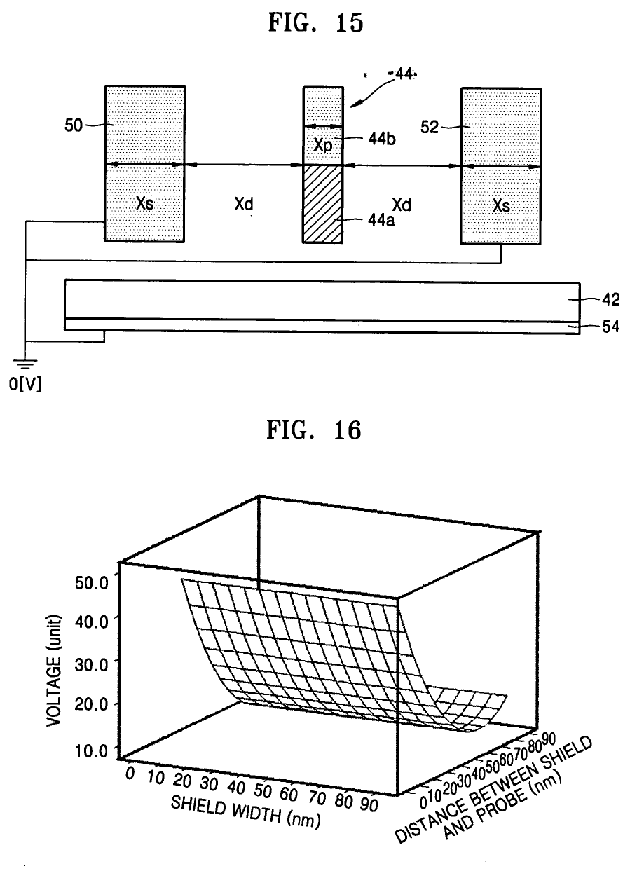

In order to enhance the sensitivity in reading data from the recording medium 42 using the electrical read head 40, the first and second shield layers 50 and 52 of the electrical read head 40 are grounded as shown in FIG. 8 (hereinafter, referred to as a first embodiment), or grounded together with the conductive layer 54 as shown in FIG. 15 (hereinafter, referred to as a second embodiment).

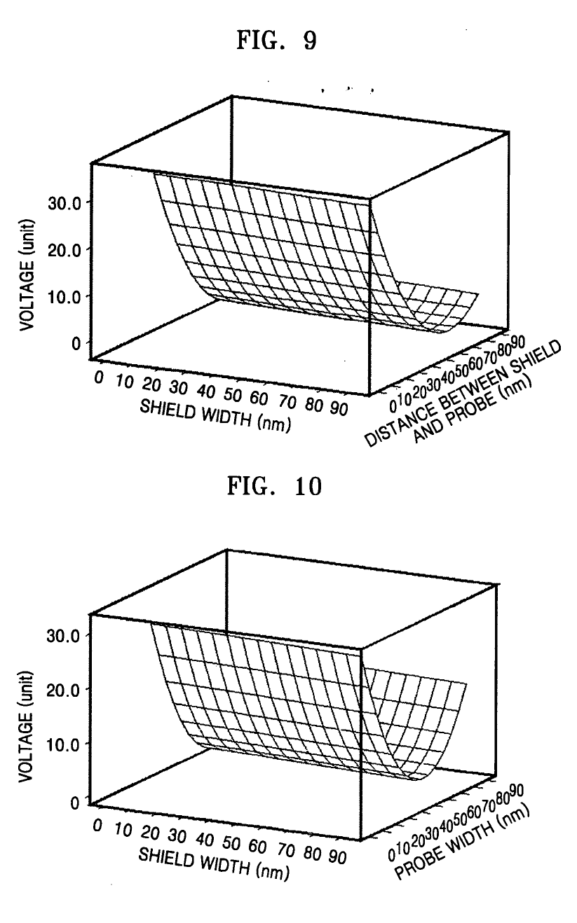

FIG. 9 is a three-dimensional graph illustrating a variation of a read voltage according to the widths Xs of the shield layers 50 and 52 and the distances Xd between the core portion 44 and the shield layers 50 and 52 in the first embodiment. FIG. 10 is a three-dimensional view illustrating a variation of a read voltage according to the widths Xs of the shield layers 50 and 52 and the width Xp of the core portion 44 in the first embodiment.

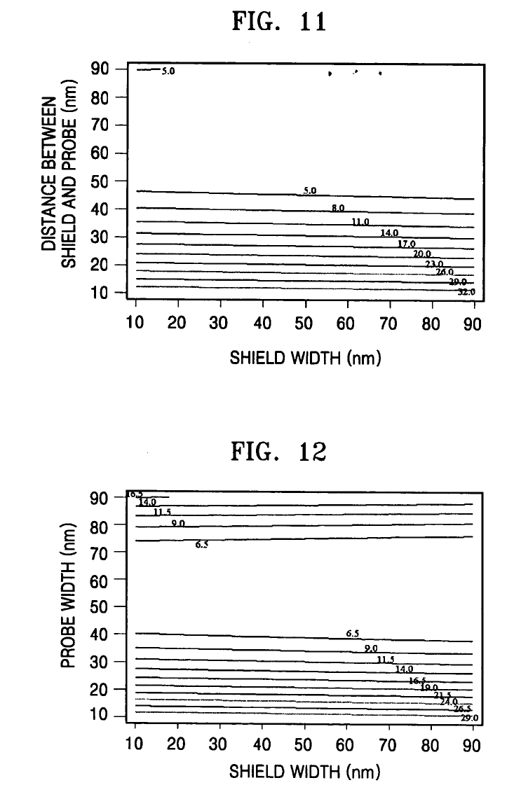

Referring to the FIGS. 9 and 10, the read voltage becomes higher as the width Xp of the core portion 44 is smaller. Also, the read voltage becomes higher as the distance between the shield layers 50 and 52 and the core portion 44 is smaller. However, the variation of the read voltage is independent of the variation of the widths Xs of the shield layers 50 and 52. These are supported by FIGS. 11 and 12. FIG. 11 is a graph illustrating a variation of an equipotential line for a read voltage using the widths Xs of the shield layers 50 and 52 and the distance Xd between the shield layers 50 and 52 and the core portion 44 as parameters. FIG. 12 is a graph illustrating a variation of an equipotential line for a read voltage using the width Xs of the shield layers 50 and 52 and the width Xp of the core portion 44 as parameters. Referring to FIGS. 11 and 12, the equipotential line for a read voltage varies when the distance Xd between the shield layers 50 and 52 and the core portion 44 and the width Xp of the core portion 44 change. On the other hand, the equipotential line for a read voltage does not vary when the widths Xs of the shield layers 50 and 52 change. Accordingly, the read voltage does not vary although the widths Xs of the shield layers 50 and 52 are varied.

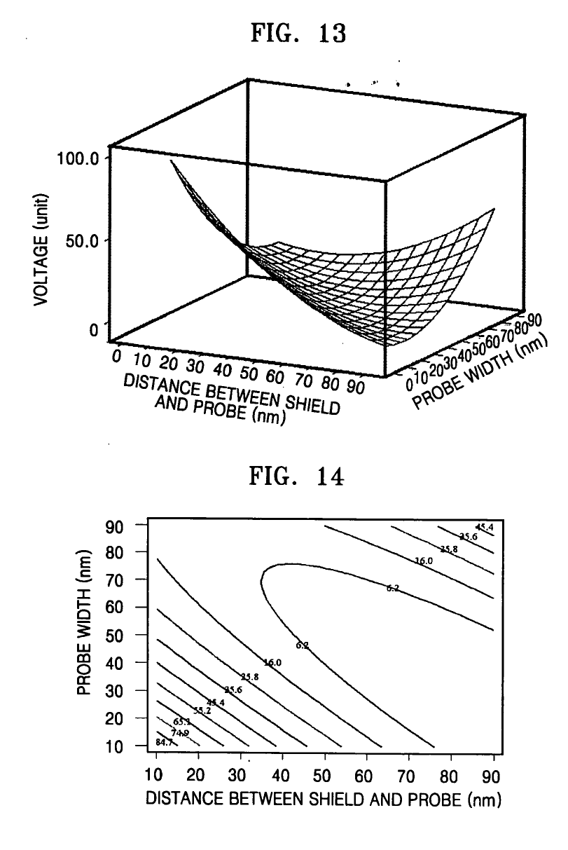

FIG. 13 is a three-dimensional view illustrating a variation of a read voltage according to the distance Xd between the shield layers 50 and 52 and the width Xp of the core portion in the first embodiment. Referring to FIG. 13, the read voltage becomes higher as the width Xp of the core portion 44 becomes narrower and the distance Xd between the shield layers 50 and 52 and the core portion 44 becomes smaller. This can be inferred from FIGS. 9 and 10.

FIG. 14 illustrates the result in FIG. 13 using a variation of an equipotential line for a read voltage.

Referring to FIG. 14, the read voltage in the equipotential line increases as the width Xp of the core portion 44 and the distance Xd between the shield layers 50 and 52 and the core portion 44 are smaller.

In FIGS. 11, 12 and 14, the numbers written on each equipotential line represent the read voltage of the corresponding equipotential line for a read voltage.

In an exemplary embodiment, the height of the core portion may be in a range of 0.5 Xd to 1.5 Xd.

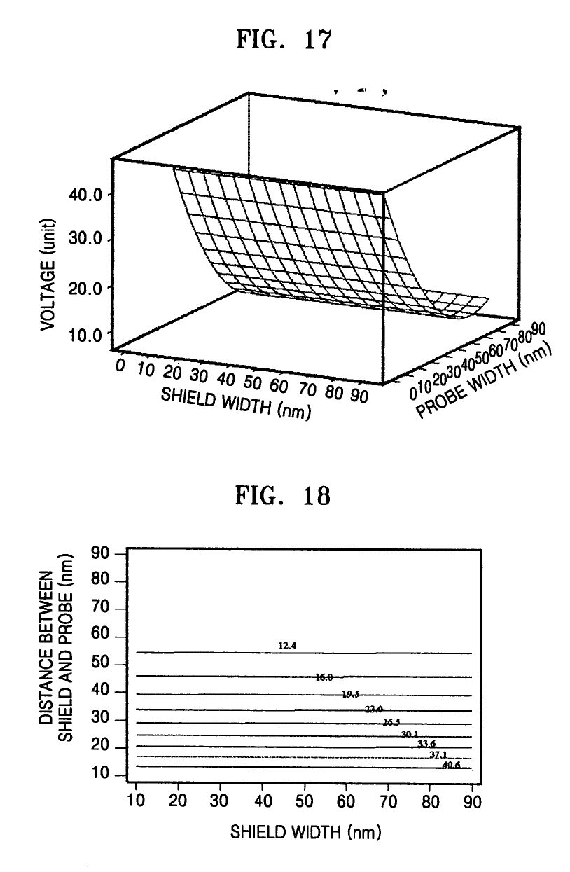

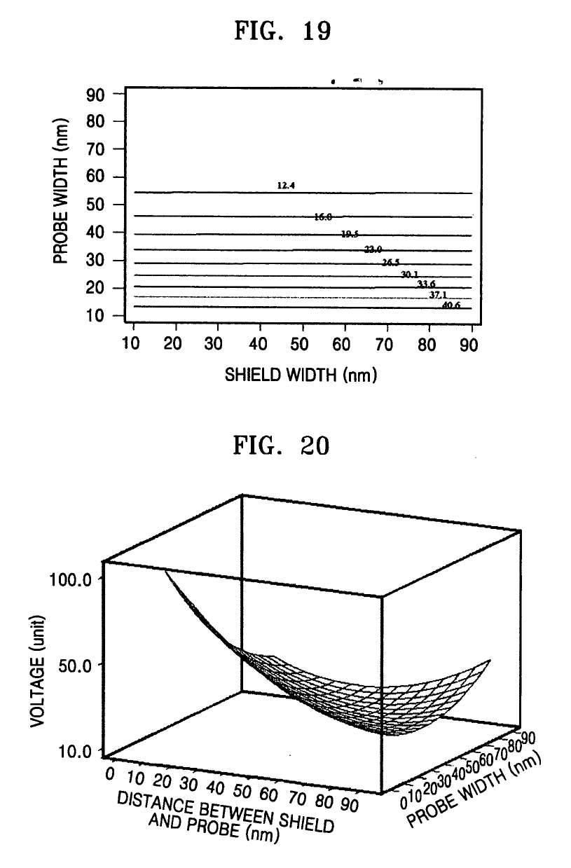

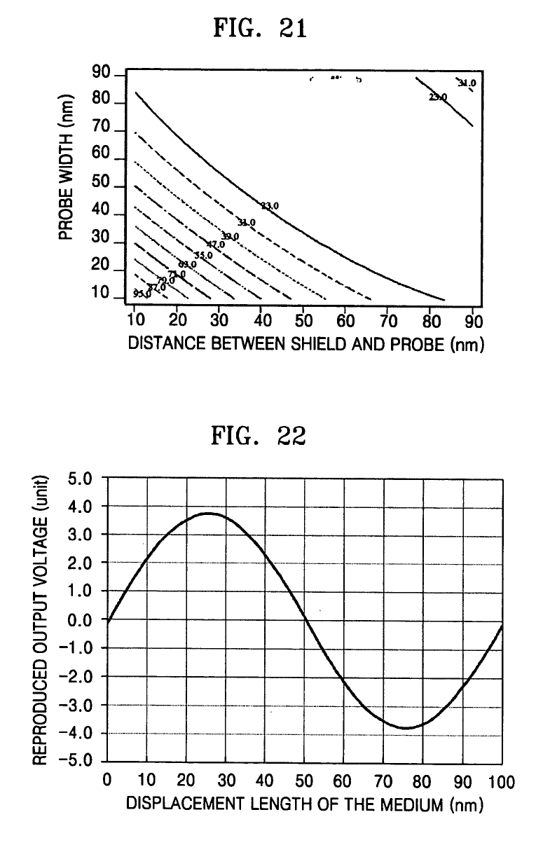

FIGS. 16 through 21 are graphs illustrating variations of the read voltage and the equipotential line for a read voltage according to a variation of the widths Xs of the shield layers 50 and 52 and at least one of the distance Xd between the shield layers 50 and 52 and the core portion 44 and the width Xp of the core portion 44 in the second embodiment. FIGS. 16 through 21 are similar with FIGS. 9 through 14 except that fact that the read voltage increases slightly. Accordingly, the detailed descriptions of FIGS. 16 through 21 will be omitted.

When the first and second shield layers 50 and 52 are not provided, that is, when only the core portion 44 is provided, the variation of the read voltage and the equipotential line for a read voltage are identical to those in the FIGS. 2 and 3.

FIGS. 22 through 24 are graphs illustrating an output of a read voltage when a recording medium moves about 100 nm in a case where the width Xs of the shield layers 50 and 52 is 50 nm, the distance Xd between the shield layers 50 and 52 and the core portion 44 is 10 nm, and the width Xp of the core portion 44 is 50 nm.

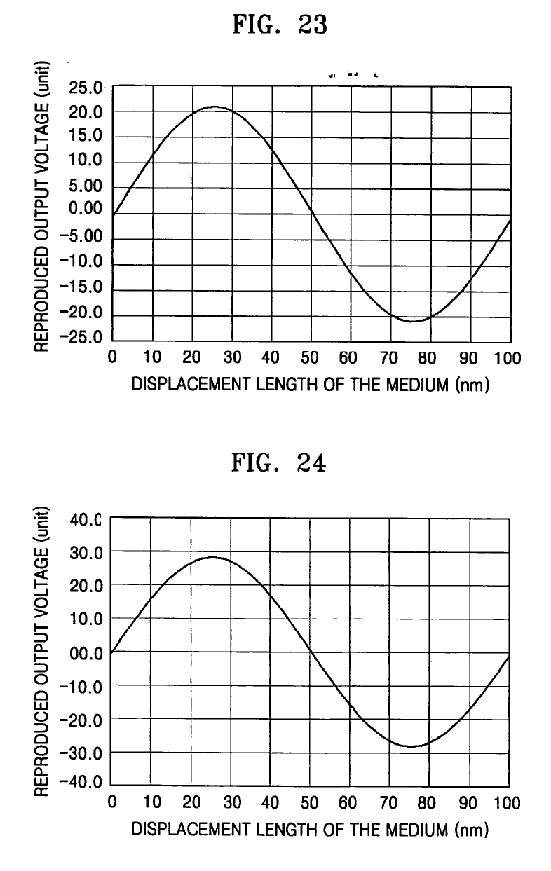

FIG. 22 is a graph of the first embodiment without shield layers 50 and 52. FIGS. 23 and 24 are graphs of the second embodiment with the first and second shield layers 50 and 52.

Referring to FIG. 22, when the shield layers 50 and 52 are not provided, the read voltage does not quite reach 8V. Referring to FIG. 23, the read voltage slightly exceeds 40V in the first embodiment. Referring to FIG. 24, the read voltage slightly exceeds 55V and does not reach 60V in the second embodiment.

As mentioned above, in the electrical read head of the present invention, the surface facing the recording medium has a plane structure instead of a sharp structure. Accordingly, as the width of the core portion actually used to record/read data is thinner and the distance between the core portion and the shield layer is smaller, the read voltage increases more. This leads to the increase of both the resolution power and the sensitivity of the electrical read head. Accordingly, the present invention can increase the track density of the recording medium, that is, Track-Per-Inch (TPI), and signal-to-noise ratio.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-20. (canceled)

21. A ligating band dispensing device comprising:
(a) a supporting structure comprising a substantially cylindrical support surface adapted to receive a plurality of ligating bands and a trigger line on an outer surface thereof, wherein the support surface has a proximal end and a distal end and a channel extending axially therethrough from the distal end to the proximal end, wherein the support surface includes at least one primary ridge maintaining the plurality of ligating bands in a position remote from the trigger line, and wherein the at least one primary ridge includes a plurality of transverse ridges on an outer face; and
(b) a plurality of ligating bands stretched onto the support surface;
wherein the ligating bands and the transverse ridges on the support surface are dimensioned to induce a rolling action, the width of the bands when stretched on the support surface being substantially the same as or less than the pitch of the transverse ridges on the support surface.

22. The ligating band dispensing device according to claim 21, wherein the width of the bands when stretched on the support surface is approximately 0.060 inches.

23. The ligating band dispenser device according to claim 22, wherein the height of the transverse ridges is approximately 0.018 inches.

24. The ligating band dispensing device according to claim 22, wherein the pitch of the transverse ridges on the support surface is approximately 0.060 inches.

25. The ligating band dispensing device according to claim 21, wherein the support surface has an outer diameter of approximately 0.4 to 0.6 inches.

26. The ligating band dispensing device according to claim 21, wherein the support surface further includes a plurality of slots disposed on the distal end for retaining the trigger line, and wherein the support surface includes a total number of the slots so that, when the ligating bands and the trigger line are arranged on the support surface, the trigger line passes through each slot at most once.

27. The ligating band dispensing device according to claim 21, comprising a plurality of shallow slots and deeper slots, wherein the plurality of shallow slots and deeper slots are grouped in slot pairs, each of the slot pairs including one of the shallow slots and an adjacent one of the deeper slots, and wherein each of the slot pairs is disposed between a corresponding pair of the primary ridges.

28. The ligating band dispensing device according to claim 21, the outer surface of the support surface further including at least one axially extending secondary ridge, the at least one secondary ridge maintaining the ligating bands remote from the support surface.

29. A method of deploying ligating bands comprising:
providing a supporting structure comprising a substantially cylindrical support surface adapted to receive a plurality of ligating bands and a trigger line on an outer surface thereof, the support surface having a proximal end and a distal end and a channel extending axially therethrough from the distal end to the proximal end, the support surface including at least one axially extending primary ridge disposed on the outer surface, said at least one primary ridge maintaining the plurality of ligating bands in a position remote from the trigger line, wherein said at least one primary ridge includes a plurality of transverse ridges on an outer face;
providing a plurality of ligating bands stretched onto the support surface, wherein the ligating bands and the transverse ridges on the support surface are dimensioned such that the width of the bands when stretched on the support surface is substantially the same as or less than the pitch of the transverse ridges on the support surface so that the ligating bands fit between the transverse ridges; and
actuating the trigger line so as to induce a rolling action in said ligating bands toward the distal end of the supporting structure.

30. The method of deploying ligating bands according to claim 29, wherein the height of the transverse ridges is dimensioned to insure that the ligating bands are sufficiently held back by the transverse ridges to induce a rolling action.

31. The method of deploying ligating bands according to claim 29, wherein each ligating band is positioned adjacent a corresponding transverse ridge with the corresponding transverse ridge positioned between the corresponding ligating band and the distal end of said support surface, and wherein the plurality of ligating bands are arranged on the support surface such that only one transverse ridge is located between two adjacent ligating bands.
